(19) United States
(12) Patent Application Publication
(10) Pub. No.: US 2024/0309963 A1
(43) Pub. Date: Sep. 19, 2024

(54) FLOW CONTROL SYSTEM

(71) Applicants: Matthew A. Kull, Casper, WY (US); Justin A. Wollerman, Casper, WY (US)

(72) Inventors: Matthew A. Kull, Casper, WY (US); Justin A. Wollerman, Casper, WY (US)

(73) Assignee: Simple Injections LLC, Casper, WY (US)

(21) Appl. No.: 18/417,714

(22) Filed: Jan. 19, 2024

Related U.S. Application Data
(60) Provisional application No. 63/576,139, filed on Jan. 19, 2023.

(51) Int. Cl. F16K 31/06; F16K 27/02

(52) U.S. Cl. CPC F16K 31/0675; F16K 27/0209

(57) ABSTRACT

A flow control system includes a check valve and a check valve inhibitor. The check valve, such as an automatic check valve, has a flow channel extending from an inlet to an outlet and a valving mechanism positioned between the inlet and the outlet. The check valve inhibitor is positionable in proximity to the valving mechanism of the check valve to control the operation of the check valve. The check valve inhibitor includes a magnetic field generator capable of generating a magnetic field that is selectively operable on the valving mechanism, wherein the check valve inhibitor can place the check valve in an uninhibited condition where flow in the outlet to inlet direction is blocked, and wherein the check valve inhibitor can place the check valve in an inhibited condition where flow in the outlet to inlet direction is allowed.

### PRIORITY

The present application claims the benefit of domestic priority based on U.S. Provisional Patent Application No. 63/576,139 filed on Jan. 19, 2023, the entirety of which is incorporated herein by reference.

### BACKGROUND

A check valve allows the flow of fluid in one direction and prevents the flow in the opposite direction. Though effective in its intended operation, a conventional check valve is beholden to that operation and lacks flexibility in its use.

A check valve, also known as a one-way valve and other names, has an entry port through which fluid enters and an exit port through which fluid exits. Between the entry port and the exit port is a valving mechanism that serves to make sure the flow is only from the entry port to the exit port. In automatic check valves, the valving mechanism functions automatically by nature of its design and does not need to be actuated or controlled. Typically, with a conventional automatic check valve, there is a blocking member, such as a ball or disk, that blocks flow in the exit-to-entrance direction but is moved to a non-blocking position by flow in the entrance-to-exit direction so that flow in that direction is permitted.

A problem with conventional automatic check valves is that it can be difficult or impossible to permit flow in the exit-to-entrance direction should it ever be desirable to do so. In such case, the check valve will usually need to be disconnected from the system or some bypass system would need to be constructed or implemented around the check valve. This lack of flexibility and control can lead to great expense and/or loss of time and resources. Sometimes, an entire flow system will need to be shut down due to the inability to inhibit the operation of an automatic check valve.

Therefore, there is a need for an improved flow control system. There is further a need for a flow control system that can selectively inhibit the operation of a check valve, particularly an automatic check valve. There is further a need for a controllable check valve to be used in a flow system that enables flow through the system to be controlled.

### SUMMARY

The present invention satisfies these needs. In one aspect of the invention, an improved flow control system is provided.

In another aspect of the invention, a flow control system controls the flow of fluid through a check valve.

In another aspect of the invention, a flow control system controls the flow of fluid through a check valve by selectively inhibiting the operation of the check valve.

In another aspect of the invention, a flow control system controls the flow of fluid through an automatic check valve by selectively inhibiting the operation of the automatic check valve.

In another aspect of the invention, a flow control system uses a selectively appliable magnetic field to control the operation of a check valve.

In another aspect of the invention, a flow control system uses a selectively appliable magnetic field to selectively inhibit the operation of a check valve.

In another aspect of the invention, a flow control system includes a magnetic field application mechanism that applies a magnetic field to a check valve to inhibit operation of the check valve and removes or changes the magnetic field to allow for normal operation of the check valve.

In another aspect of the invention, flow control system includes a controllable check valve that is positionable in a flow system to allow for the control of flow through the system.

In another aspect of the invention, a method of controlling flow comprises applying a magnetic field to inhibit operation of a check valve.

In another aspect of the invention, a method of controlling flow through a check valve comprises providing a flow control system as disclosed herein and/or in any combination of features as disclosed herein.

In another aspect of the invention, a flow control system comprises a check valve having a flow channel extending from an inlet to an outlet, the check valve having a valving mechanism positioned between the inlet and the outlet; and a check valve inhibitor positionable in proximity to the valving mechanism to control the operation thereof, the check valve inhibitor comprising a magnetic field generator capable of generating a magnetic field that is selectively operable on the valving mechanism, wherein the check valve inhibitor can place the check valve in an uninhibited condition where flow in the outlet to inlet direction is blocked, and wherein the check valve inhibitor can place the check valve in an inhibited condition where flow in the outlet to inlet direction is allowed.

In another aspect of the invention, a flow control system comprises an automatic check valve having a flow channel extending from an inlet to an outlet, the automatic check valve having a valving mechanism positioned between the inlet and the outlet; and a check valve inhibitor positionable in proximity to the valving mechanism to control the operation thereof, the check valve inhibitor comprising a magnetic field generator capable of generating a magnetic field that is selectively operable on the valving mechanism, wherein the check valve inhibitor can place the automatic check valve in an uninhibited condition where flow in the outlet to inlet direction is blocked, and wherein the check valve inhibitor can place the automatic check valve in an inhibited condition where flow in the outlet to inlet direction is allowed.

In another aspect of the invention, a flow control system comprises a check valve having a flow channel extending from an inlet to an outlet, the check valve having a valving mechanism positioned between the inlet and the outlet; and a check valve inhibitor positionable in proximity to the valving mechanism to control the operation thereof, the check valve inhibitor comprising a magnetic field generator capable of generating a magnetic field that is selectively operable on the valving mechanism, wherein the check valve inhibitor can place the check valve in an uninhibited condition where flow in the outlet to inlet direction is blocked, and wherein the check valve inhibitor can place the check valve in an inhibited condition where flow in the outlet to inlet direction is allowed, wherein the check valve inhibitor comprises an inhibition actuator that controls the selectively operable magnetic field in a manner that moves the check valve from the uninhibited condition to the inhibited condition.

In another aspect of the invention, a flow control system comprises a check valve having a flow channel extending from an inlet to an outlet, the check valve having a valving mechanism positioned between the inlet and the outlet; and a check valve inhibitor positionable in proximity to the valving mechanism to control the operation thereof, the check valve inhibitor comprising a magnetic field generator capable of generating a magnetic field that is selectively operable on the valving mechanism, wherein the check valve inhibitor can place the check valve in an uninhibited condition where flow in the outlet to inlet direction is blocked, and wherein the check valve inhibitor can place the check valve in an inhibited condition where flow in the outlet to inlet direction is allowed, wherein the check valve inhibitor comprises an inhibition actuator that controls the selectively operable magnetic field in a manner that moves the check valve from the uninhibited condition to the inhibited condition, wherein the magnetic field generator is a permanent magnet, and wherein the inhibition actuator controls the position of the permanent magnet relative to the valving mechanism.

In another aspect of the invention, a flow control system comprises a check valve having a flow channel extending from an inlet to an outlet, the check valve having a valving mechanism positioned between the inlet and the outlet; and a check valve inhibitor positionable in proximity to the valving mechanism to control the operation thereof, the check valve inhibitor comprising a magnetic field generator capable of generating a magnetic field that is selectively operable on the valving mechanism, wherein the check valve inhibitor can place the check valve in an uninhibited condition where flow in the outlet to inlet direction is blocked, and wherein the check valve inhibitor can place the check valve in an inhibited condition where flow in the outlet to inlet direction is allowed, wherein the check valve inhibitor comprises an inhibition actuator that controls the selectively operable magnetic field by adjusting the position of the magnetic field generator, wherein the magnetic field generator is positionable by the inhibition actuator in a first position to place the check valve in the uninhibited condition, wherein the magnetic field generator is positionable by the inhibition actuator in a second position to place the check valve in the inhibited condition, and wherein the inhibition actuator comprises a biasing mechanism that biases the magnetic field generator towards the first position or the second position.

In another aspect of the invention, a check valve inhibitor for a check valve in a flow control system comprises an attachment mechanism adapted to allow the check valve inhibitor to be attached to a check valve, the check valve having a flow channel extending from an inlet to an outlet, the check valve having a valving mechanism positioned between the inlet and the outlet; and a magnetic field generator capable of generating a magnetic field that is selectively operable on the valving mechanism, wherein the check valve inhibitor is adapted to control the operation of the check valve by being able to selectively place the check valve in an uninhibited condition where flow in the outlet to inlet direction is blocked and by being able to selectively place the check valve in an inhibited condition where flow in the outlet to inlet direction is allowed.

In another aspect of the invention, a method of controlling a check valve comprises providing an automatic check valve, the automatic check valve having a flow channel extending from an inlet to an outlet, the check valve having a valving mechanism positioned between the inlet and the outlet; positioning a check valve inhibitor in proximity to the valving mechanism of the automatic check valve, the check valve inhibitor comprising a magnetic field generator; and operating the magnetic field generator to control the operation of the check valve by selectively being able to place the check valve in an uninhibited condition where flow in the outlet to inlet direction is blocked, and selectively being able to place the check valve in an inhibited condition where flow in the outlet to inlet direction is allowed.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1A is a schematic partial cross-sectional side view of a flow control system of the invention with a check valve in an uninhibited condition;

FIG. 1B is a schematic partial cross-sectional side view of the check valve control system of FIG. 1A with a check valve in an inhibited condition;

FIG. 2A is a schematic partial cross-sectional side view of another version of a flow control system of the invention with a check valve in an uninhibited condition;

FIG. 2B is a schematic partial cross-sectional side view of the flow control system of FIG. 2A with a check valve in an inhibited condition;

FIG. 3A is a schematic partial cross-sectional side view of another version of a flow control system of the invention with a check valve in an uninhibited condition;

FIG. 3B is a schematic partial cross-sectional side view of the flow control system of FIG. 3A with a check valve in an inhibited condition;

FIG. 4A is a schematic partial cross-sectional side view of another version of a flow control system of the invention with a check valve in an uninhibited condition;

FIG. 4B is a schematic partial cross-sectional side view of the flow control system of FIG. 4A with a check valve in an inhibited condition;

FIG. 5A is a schematic partial cross-sectional side view of another version of a flow control system of the invention with a check valve in an uninhibited condition;

FIG. 5B is a schematic partial cross-sectional side view of the flow control system of FIG. 5A with a check valve in an inhibited condition;

FIG. 6A is a schematic partial cross-sectional side view of another version of a flow control system of the invention with a check valve in an uninhibited condition;

FIG. 6B is a schematic partial cross-sectional side view of the flow control system of FIG. 6A with a check valve in an inhibited condition;

FIG. 7A is a schematic partial cross-sectional side view of another version of a flow control system of the invention with a check valve in an uninhibited condition;

FIG. 7B is a schematic partial cross-sectional side view of the flow control system of FIG. 7A with a check valve in an inhibited condition;

FIG. 8A is a schematic partial cross-sectional side view of another version of a flow control system of the invention with a check valve in an uninhibited condition;

FIG. 8B is a schematic partial cross-sectional side view of the flow control system of FIG. 8A with a check valve in an inhibited condition;

FIG. 9A is a schematic partial cross-sectional side view of another version of a flow control system of the invention with a check valve in an uninhibited condition;

FIG. 9B is a schematic partial cross-sectional side view of the flow control system of FIG. 9A with a check valve in an inhibited condition;

FIG. 10A is a schematic side view of the flow control system of FIG. 9A;

FIG. 10B is a schematic top view of the flow control system of FIG. 9A;

FIG. 11A is a schematic partial cross-sectional side view of another version of a flow control system of the invention with a check valve in an uninhibited condition; and

FIG. 11B is a schematic partial cross-sectional side view of the flow control system of FIG. 11A with a check valve in an inhibited condition.

### DESCRIPTION

The present invention relates to a system for controlling flow of a fluid. In particular, the invention relates to a flow control system useful for inhibiting operation of a check valve. Although the invention is illustrated and described in the context of being useful for controlling or inhibiting flow through an automatic check valve and/or in a flow system, the present invention can be used in other ways, as would be readily apparent to those of ordinary skill in the art. Accordingly, the present invention should not be limited just to the examples and embodiments described herein.

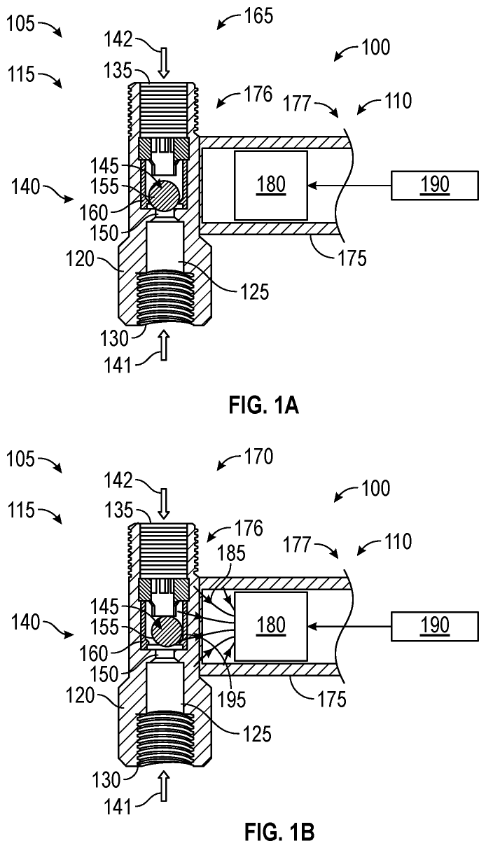

FIGS. 1A and 1B show a flow control system 100 according to one version of the invention. The flow control system 100 includes a check valve 105 and a check valve inhibitor 110. The check valve inhibitor 110 is positionable on or near the check valve 105 to selectively inhibit the normal operation of the check valve 105 and thereby control the flow of fluid through the check valve 105. By check valve 105 it is meant any valve that when not inhibited by the check valve inhibitor 110 is operative to prevent flow in one direction and allow flow in another direction. The check valve 105 may include one or more features from any one of many commercially available check valves, which are also commonly referred to as a one-way valve, a non-return valve, a reflux valve, a retention valve, a foot valve, backflow preventer, and the like in the art. The check valve 105 may be an automatic check valve 115, as shown in FIGS. 1A and 1B. By automatic check valve it is meant a check valve that operates to allow flow in one direction and prevent flow in another direction by nature of its physical design and does not need separate actuation, control, and/or power to perform its normal function.

The check valve 105 of the flow control system 100 includes a check valve body 120 within which is a flow channel 125 that extends from a valve inlet 130 to a valve outlet 135. The flow channel 125 is adapted to allow a fluidic gas or liquid that enters the check valve 105 through the valve inlet 130 to flow through the check valve 105 and exit through the valve outlet 135. One or both of the valve inlet 130 and the valve outlet 135 can be equipped with an attachment mechanism, such as internal or external threads or flanges or the like, that allow the valve body 120 to be attached to tubes, pipes, or other fluid containers in an overall flow system. Within the valve body 120 and within the flow channel 125 at an intermediate position between the valve inlet 130 and the valve outlet 135 is a valving mechanism 140. The valving mechanism 140 is designed to, in its normal operation, provide for one-way flow of fluid through the flow channel 125 in a first direction or flow direction 141, such as an inlet-to-outlet direction, and to prevent flow in a second direction or counter flow direction 142, such as an outlet-to-inlet direction. In the version shown, the valving mechanism 140 includes a blocking member 145 that is sized and shaped to be positionable in a position, as shown in FIG. 1A, to block or cover a through opening 150 of the flow channel 125 in the region of the valving mechanism 140. In the particular version shown in FIG. 1A, the blocking member 145 is in the form of a ball 155 that is receivable on a seat 160 positioned at the through opening 150.

FIG. 1A shows the flow control system 100 in an uninhibited condition 165. By uninhibited condition it is meant that the check valve 105 of the flow control system 100 operates in its normal fashion as it would in the absence of any influence from the check valve inhibitor 110. In the uninhibited condition 165, the check valve 105 operates in the manner of a conventional check valve and allows flow in the flow direction 141 and prevents flow in the counter flow direction 142. In the version of FIG. 1A, flow in the counter flow direction 142 presses the ball 155 sealingly against the seat 160 and blocks flow through the through opening 150. On the other hand, flow in the flow direction 141 pushes the ball 155 off the seat 160 and allows the fluid to flow through the through opening 150, around the ball 155 and to then continue flowing through the flow channel 125 to the valve outlet 135. In the particular version shown, a funnel shaped member is provided that has multiple openings along its bottom and sides is provided on the valve outlet side of the region of the valving mechanism 140. The funnel shaped member serves to keep the ball 155 inside the check valve 105, and it limits the travel of the ball 155 to allow for faster blocking of the through opening 150 when there is counter flow 142 that is to be prevented. The seat 160 in the particular version shown is made up of a plastic, such as polytetrafluoroethylene, part that is held in place by a rib portion. The seat 160 can take on any suitable shape and material that receives the blocking member 145 in a scaling manner when there is counter flow 142 that is to be prevented.

FIG. 1B shows the flow control system 100 in an inhibited condition 170. By inhibited condition it is meant that check valve 105 is inhibited, at least partially, from operating in its normal fashion. For example, when the flow control system 100 is in the inhibited condition 170, the check valve 105 will allow at least partial flow of fluid in the counter flow direction 142. The check valve inhibitor 110 serves to selectively move the flow control system 100 from the uninhibited condition 165 to the inhibited condition 170 and/or to selectively move the flow control system 100 from the inhibited condition 170 to the uninhibited condition 165. The flow control system 100 thus controls the operation of the check valve 105 so that the check valve 105 can selectively operate where it either allows flow in the flow direction 141 and prevents flow in the counter-flow direction 142 or where it allows flow in both the flow direction 141 and the counter flow direction 142 by inhibiting the flow blocking abilities of the valving mechanism 140.

The check valve inhibitor 110 of the version of the flow control system 100 of FIGS. 1A and 1B has a housing 175 having a forward end 176 and a rearward end 177. Within the housing 175, near the forward end 176, a magnetic field generator 180 is provided. The magnetic field generator 180 produces a magnetic field 185, and the magnetic field 185 is capable of acting on the valving mechanism 140 of the check valve 105 in a manner that inhibits the normal operation of the check valve 105. An inhibition actuator 190 serves to control the operation and/or position of the magnetic field generator 180 so that the magnetic field 185 can be selectively applied or not applied to the valving mechanism 140. The inhibition actuator 190 can thus alter the check valve 205 from the uninhibited condition 165 of FIG. 1A to the inhibited condition 170 of FIG. 1B and back again. Optionally, the inhibition actuator 190 can be manually controlled, electronically controlled, programmed to operate in a predetermined routine in an overall flow process, and/or can be responsive to one or more conditions in the overall flow process and adjust the condition of the check valve 195 accordingly.

In the particular version of FIGS. 1A and 1B, the blocking member 145 of the valving mechanism 140, such as the ball 155, is made of a material that is attracted by the magnetic field 185. For example, the ball 155 can contain one or more ferromagnetic materials, such as iron, steel, cobalt, nickel, and molybdenum, and in one particular version is made of stainless steel, such as alloy 2507. When the magnetic field 185 is applied to the side of the region of the valving mechanism 140 and is sufficiently strong and/or close to the ball 155, the magnetic field 185 will cause the ball 155 to move off of the seat 160 and towards the side wall 195 of the check valve 105, as shown in FIG. 1B. By being unseated, the ball 155 no longer completely blocks the through opening 150 and thus allows for flow in the counter flow direction 142. Alternatively, the ball 155 can be made of a diamagnetic material, such as bismuth, copper, and mercury, that can be repelled by a magnetic field and instead of being attacted to the magnetic field 190 it can be repulsed so that it is moved to the opposite side of that which is shown in FIG. 1B. The forward end 176 of the housing 175 is positionable on or near the check valve 105 in proximity to the valving mechanism 140, as will be described.

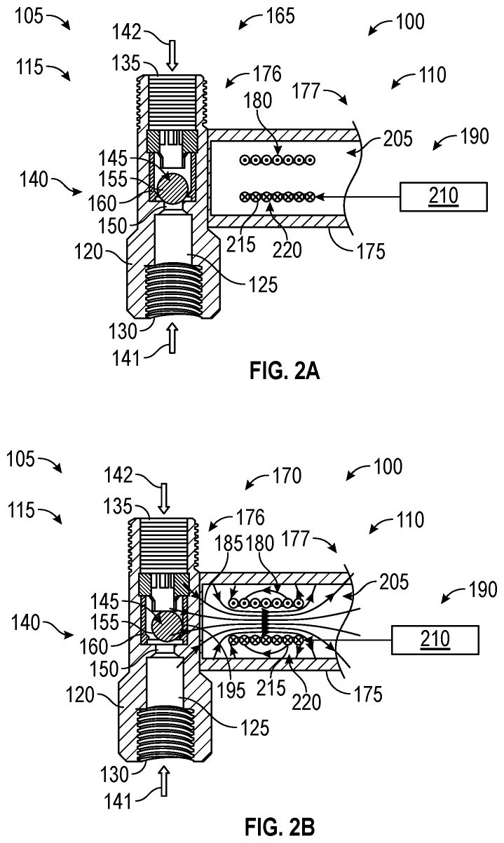

FIGS. 2A and 2B show another version of a flow control system 100 of the invention that is similar to the version of FIGS. 1A and 1B. In the version of 2A and 2B, the magnetic field generator 180 is an electromagnet 205 and the inhibition actuator 190 is an electromagnetic actuator 210 that communicates with the electromagnet 205 to control the magnetic field 185 generated by the electromagnet 205. By electromagnet it is meant a type of magnet where a magnetic field is produced by an electric current. In the version shown, the electromagnet 205 is made up of a wire 215 that is wound into a coil 220. The electromagnetic actuator 210 supplies a current to the wire 215, and the current through the wire 215 creates a magnetic field at the center of the coil 220. The center of the coil 220 can also include a magnet core made of ferromagnetic material. The strength of the magnetic field 185 is determined by the amount of current provided by the electromagnetic actuator, and when the current is discontinued, there is no magnetic field 185 generated. In one version, such as the one shown in FIGS. 2A and 2B, the electromagnetic actuator 210 operates in a binary manner where there is no current provided, as shown in FIG. 2A, and where there is a current provided, as shown in FIG. 2B, that is sufficient to generate a sufficiently strong magnetic field 185 that the ball 155 or other blocking member 145 is moved out of its blocking position, thereby inhibiting the normal operation of the check valve 105. In this version, the electromagnetic actuator 210 can include a simple on/off switch. In another version, the current supplied by the electromagnetic actuator 210 can be adjustable to that the strength of the magnetic field can be adjusted, which can be useful when using the check valve inhibitor 110 in different flow situations and/or with different types of check valves. Once in the inhibited condition 170 as shown in FIG. 2B, the electromagnetic actuator 210 can return the check valve 105 to the uninhibited condition 165 of FIG. 2A.

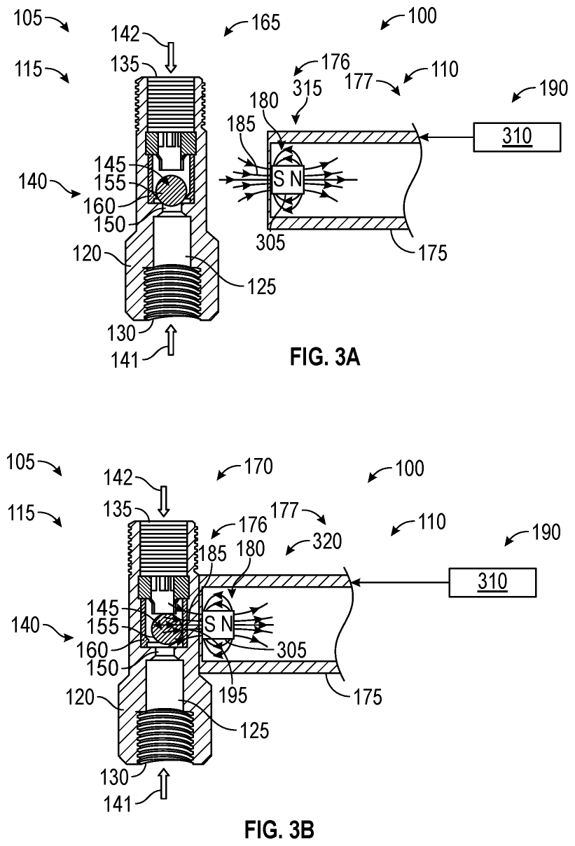

FIGS. 3A and 3B show another version of a flow control system 100 of the invention that is similar to the version of FIGS. 1A and 1B. In the version of 3A and 3B, the magnetic field generator 180 is a permanent magnet 305. By permanent magnet 305 it is meant an object that generates a magnetic field without the need for a current to be supplied to it. A permanent magnet is made of material that creates its own persistent magnetic field 185. Typically, a permanent magnet 305 is made of one or more ferromagnetic materials that are subjected to a strong magnetic field during processing to align the internal microcrystalline structure to thereby magnetize the structure.

In the version of FIGS. 3A and 3B, the inhibition of the check valve 305 is accomplished by movement of the permanent magnet 305 relative to the check valve 105. The inhibition actuator 190 in this version is a magnet location adjustment system 310. The magnet location adjustment system 310 is adapted to be able to selectively move the permanent magnet 305 or other magnetic field generator 180 from a first position 315, as shown in FIG. 3A, where the permanent magnet 305 is spaced away from the valving mechanism 140 a sufficient distance that the magnetic field 185 does not affect the valving mechanism 140 to a second position 320, as shown in FIG. 3B, where the permanent magnet 305 is sufficiently close to the valving mechanism 140 that the valving mechanism 140 is affected by the magnetic field 185. Accordingly, when the permanent magnet 305 is in the first position 315, the check valve 105 is in its uninhibited condition 165, and when the permanent magnet 305 is in the second position 320, the check valve is in its inhibited condition 170. The magnet position location system 310 can move the permanent magnet 305 back and forth between the first position 315 and the second position 320. In the particular version of FIGS. 3A and 3B, the permanent magnet position adjustment system 310 is adapted to move the housing 175 of the check valve inhibitor 110 relative to the check valve 105. The permanent magnet 305 can be affixed to the housing 175 at a position at or near the front end 176 of the housing 175.

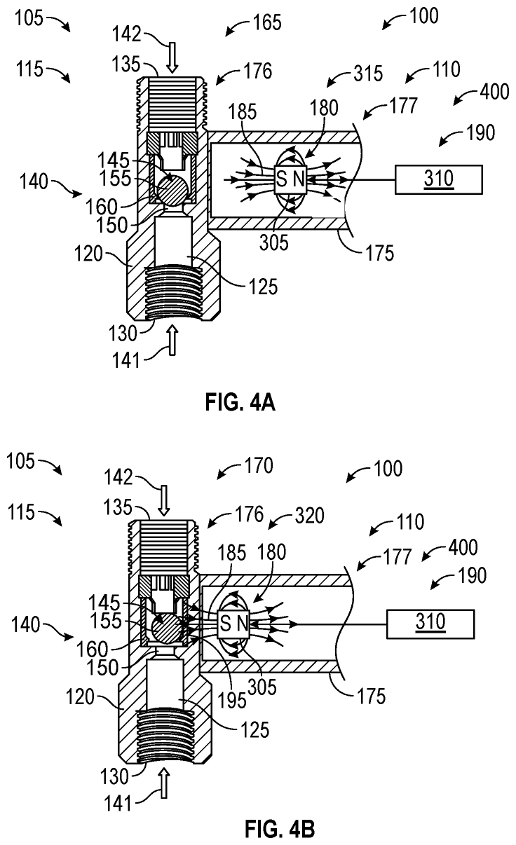

FIGS. 4A and 4B show a version of a flow control system 100 of the invention that is similar to the version of FIGS. 3A and 3B. However, in the version of FIGS. 4A and 4B, the magnet location adjustment system 310 is a magnet positioning system 400 whereby the permanent magnet 305 or other magnetic field generator 180 is moveable within or relative to the housing 175. With this version, the housing 175 can thus remain stationary relative to the check valve 105 while the permanent magnet 305 moves within the housing from the first position 315, as shown in FIG. 4A, to the second position 320, as shown in FIG. 4B. The front end 176 of the housing 175 can be positioned to abut or nearly abut the check valve body 120 at the position of the sidewall 195 to reduce the necessary magnetic strength of the magnetic field 185. Optionally, the front end 176 of the housing 175 or other part of the housing 175 can be attachable, such as by being releaseably attachable or by being permanently attached, to the check valve body 120.

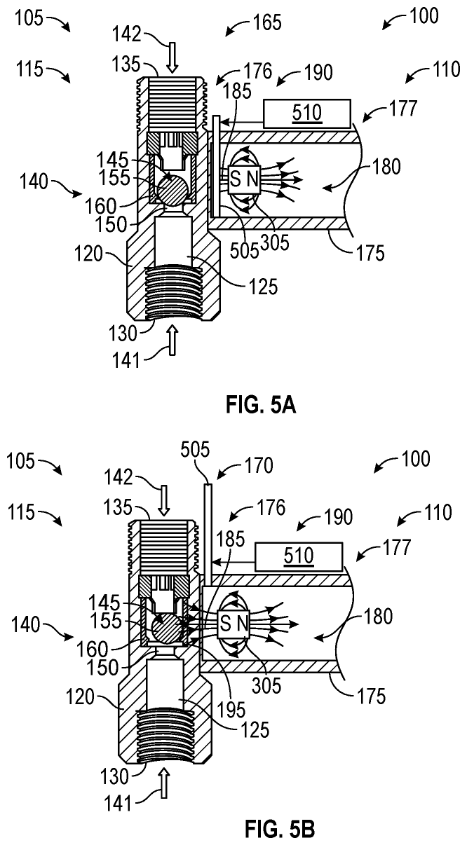

FIGS. 5A and 5B show a version of a flow control system 100 of the invention that is similar to the version of FIGS. 3A and 3B and FIGS. 4A and 4B except that instead of the permanent magnet 305 being moveable, a magnetic field blocking member 505 is provided that can selectively block the magnetic field from affecting the valving mechanism 140. The magnetic field blocking member 505 is a piece of material that shields the prevents the magnetic field 185 from passing through it. As shown in FIG. 5A, when the blocking member 505 is positioned between the permanent magnet 305 and the valving mechanism 140, the magnetic field 185 does not reach the valving mechanism 140 with sufficient strength to inhibit the normal operation of the check valve thus placing the check valve in the uninhibited condition 165. However, when the blocking member 185 is removed from the blocking position, as shown in FIG. 5B, the magnet field 305 affects the valving mechanism 140 and places it in the inhibited condition 170. In this version, the inhibition actuator 190 operates as a blocking member actuator 510 that can selectively position the blocking member 505 in the blocking position of FIG. 5A or the non-blocking position of FIG. 5B.

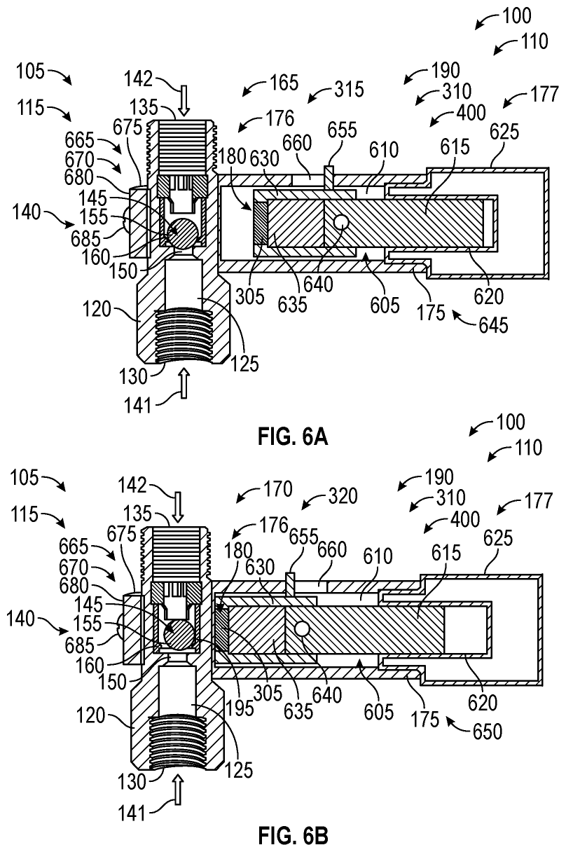

FIGS. 6A and 6B show a version of a flow control system 100 of the invention that is similar to the version of FIGS. 4A and 4B. In this version, the inhibition actuator 190 is a specific version of a magnet location system 310 and magnet position system 400 that positions the magnetic field generator 180 within the housing 175. In this version, the inhibition actuator 190 comprises a plunger mechanism 605 receiveable and moveable within an interior 610 of the housing 175. The plunger mechanism 605 comprises a plunger member 615 having one end slidably received within a channel 620 in an actuator device body 625 and a second end connected to a magnetic field generator holder 630. In the particular version shown, the magnetic field generator holder 630 holds a magnetic field generator 180 in the form of a permanent magnet 305 in the shape of a cube, cuboid, round disk, or any other suitable shaped permanent magnet that produces a sufficiently strong magnetic field for the purpose. Alternatively, the magnetic field generator 180 can be attached directly to the plunger member 615. Optionally, a spacer 635 can be provided to adjust the exact positioning of the magnetic field generator 180 within the housing without having to change the size of the plunger member 615. The magnetic field generator holder 630 and/or the magnetic field generator 180 can be attached to the plunger member 615 in any suitable manner, such as the cross pin 640 shown in FIGS. 6A and 6B or by adhesive, threads, or the like.

The plunger mechanism 605 of the inhibition actuator 190 of the flow control system 100 of FIGS. 6A and 6B allows the magnetic field generator 180 to be positioned so that the flow control system 100 can be in an uninhibited condition, as shown in FIG. 6A, or in an inhibited condition, as shown in FIG. 6B. The plunger mechanism 605 is moveable between a retracted position 645, as shown in FIG. 6A, and an extended position 650 as shown in FIG. 6B. In the retracted position 645, the plunger mechanism 605 positions the magnetic field generator 180 far enough away from the valving mechanism 140 that the magnetic field 185 generated by the magnetic field generator 180 does not operate on the valving mechanism 140 to inhibit its normal operation. In the extended position 650, the plunger mechanism 605 positions the magnetic field generator 180 close enough to the valving mechanism 140 that the magnetic field generated by the magnetic field generator 180 operates on the valving mechanism 140 to cause the normal operation to be inhibited and thereby allowing at least some flow in the counter flow direction 142. The movement of the plunger mechanism 605 from the retracted position 645 to the extended position 650 and/or from the extended position 650 to the retracted position 645 can be performed in any suitable manner. For example, in the version of FIGS. 6A and 6B, the movement can be performed manually. In this particular version, a manipulation member 655 is provided in the form of an extended portion or protrusion that extends from the plunger mechanism 605 and though a longitudinal slot 660 in the housing 175. A user can manipulate the manipulation member 655 by moving it rearwardly in the slot 660 to move the plunger member 605 towards its retracted position 645 and by moving the manipulation member 655 forwardly to move the plunger member 605 towards its extended position 650. Optionally, the plunger member 605 can be maintained in its retracted position 645 and/or its extended position 650 by friction or by the addition of a stay mechanism, such as a detent or bayonet system or the like. Alternatively, the movement of the plunger mechanism 605 can be performed by a non-manual mechanism, such as a pneumatic, electronic, and/or electromechanical mechanism, such as discussed below.

Also shown in FIGS. 6A and 6B is an optional attachment mechanism 665 that allows the check valve inhibitor 110 to be releasably or permanently attached to the check valve 105. In the particular version shown, the attachment mechanism 665 includes a clamping mechanism 670 made up of one or more extension arms 675 that extend from the front end 171 of the housing 175. A clamp member 680 can engage a side of the check valve 105 opposite to the side where the magnetic field 185 is applied. Clamping pressure can be applied by one or more screws 685 or the like. Alternatively, the check valve inhibitor 110 can be held in position by hand, adhesive, threads, brackets, or the like.

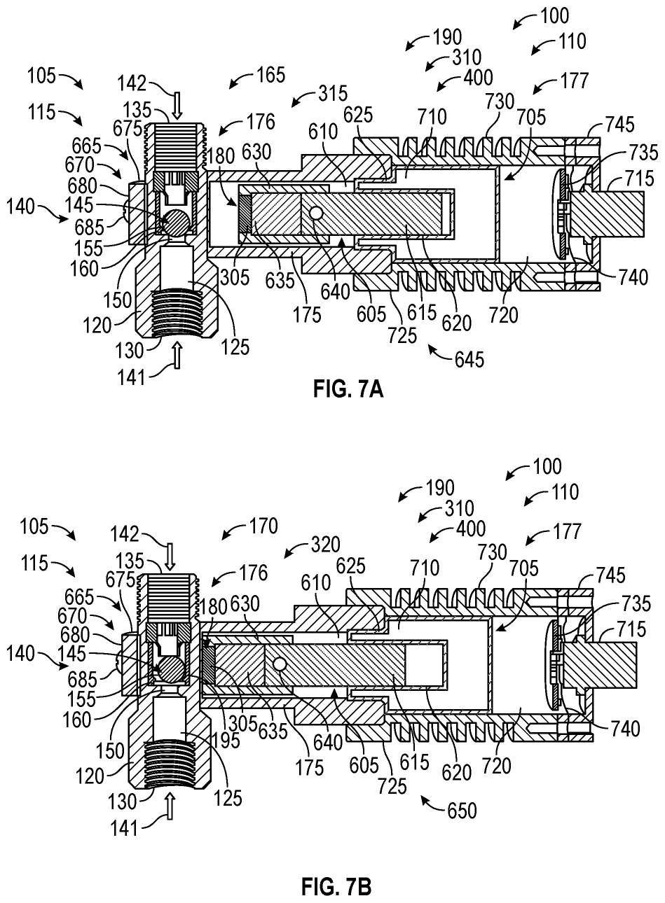

FIGS. 7A and 7B show a version of a flow control system 100 of the invention that is similar to the version of FIGS. 6A and 6B. In the version of FIGS. 7A and 7B, the plunger mechanism 605 is moved by an electromechanical actuation system 705. In this version, the actuator device body 625 houses an electromechanical actuator 710 that converts electrical energy into mechanical energy and causes the plunger mechanism 605 to move in correspondence to the electrical energy supplied. A power connector 715 is electrically connected to the electromechanical actuator 710, such as by providing one or more wires in the space 720 between the power connector 715 and the electromechanical actuator 710. The power connector is connectable to a source or power and/or contains stored power and is able to send an electrical signal to the electromechanical actuator 710 to cause the electromechanical actuator 710 to move the plunger mechanism 605 within the channel 620 from the retracted position 645, as shown in FIG. 7A, to the extended position 650, as shown in FIG. 7B. As can also be seen in FIGS. 7A and 7B, the housing 175 can include a rear housing body 725 that protects and at least partially encloses the actuator device body 625 and/or the wiring. Optionally, the rear housing body 725 can include one or more fins 730 to help transfer and dissipate heat generated by the electromechanical actuator 710 and/or to make the rear housing body 725 grippable.

FIGS. 7A and 7B also shows examples of additional features that can be included with the flow control system 100 of the invention. For example, the rear housing body 730 can be equipped with an LED circuit board 735 and a clear lens 740 that are held in place by a rear plate 745. The LED circuit board 735 that houses one or more light emitting diodes or the like and clear lens 740 can be used to indicate and/or communicate the status of the flow control system 100, such as by indicating the whether the plunger mechanism is extended or retracted and/or by indicating whether the check valve is in its uninhibited condition or its inhibited condition. The clear lens 740 allows the indication from the LED circuit board 735 to be seen on the outside of the flow control system 100. The LED circuit board 735 can be powered through the power connector 715.

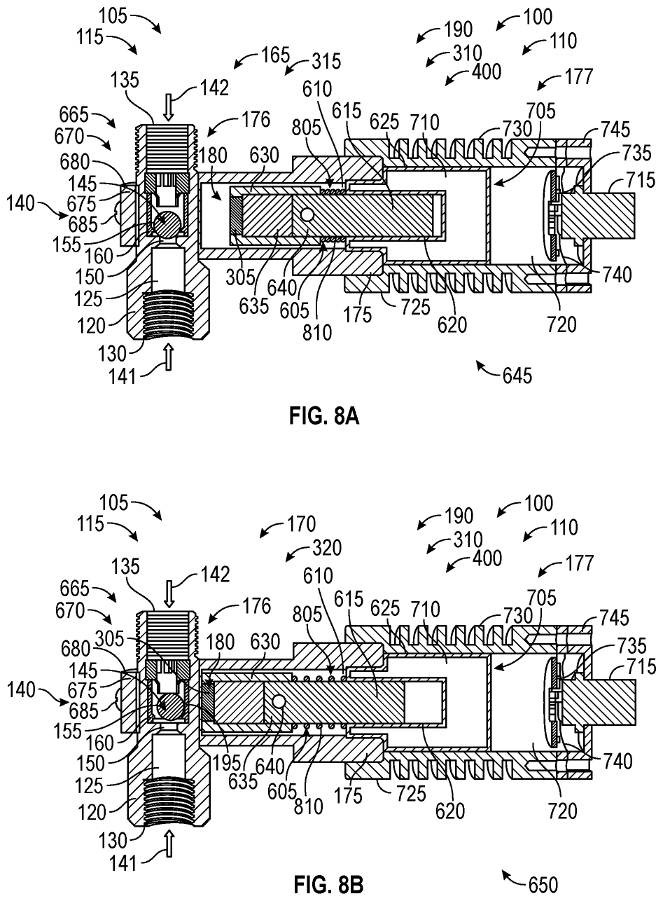

The movement of the plunger mechanism 605 to the retracted position 645 and/or to the extended position 650 by the electromechanical actuation system 705 can occur by the electromechanical actuator 710 alone or in combination with other components. For example, the electromechanical actuator 710 can be a push/pull type of actuator when a first signal can be provided to cause a pushing action on the plunger mechanism 605 and a second signal can be provided to cause a pulling on the plunger mechanism 605. In another version, the electromechanical actuator 710 can be either a push or a pull type of actuator and the movement in the opposite direction can be caused otherwise, such as by gravity, by hand, or by a system such as the one shown in FIGS. 8A and 8B.

The inhibition actuator 190 of FIGS. 8A and 8B includes an electromechanical actuator 710 and a biasing mechanism 805 as part of the electromechanism actuation system 705. For example, in the particular version shown, the biasing mechanism 805 comprises a spring 810 or other biasing member that biases the plunger mechanism 605 in a direction opposite of the direction in which the electromechanical actuator 710 urges the plunger mechanism 605. For example, in one version, the spring 810 pulls on the plunger mechanism 605 and thus biases it towards the retracted position 645. When the electromechanical actuator 710 is activated, it causes the plunger mechanism 605 to move forward towards its extended position. The pushing force of the electromechanical actuator 710 is sufficiently strong to overcome the bias of the spring 810 and cause the plunger mechanism 605 to move to its extended position 650 so long as the electromechanical actuator 710 is activated. To return the plunger mechanism to its retracted position 645, the electromechanical actuator 710 can be deactivated and the bias of the spring 810 can cause the movement to the retracted position 645. Alternatively, the plunger mechanism 605 can be biased rearwardly by a spring 810 that is a push spring that is positioned in front of the plunger mechanism 605. In another version, the spring 810 biased the plunger mechanism 605 towards the extended position 650, and the electromechanical actuator 710 moves the plunger mechanism 605 rearwardly when it is activated.

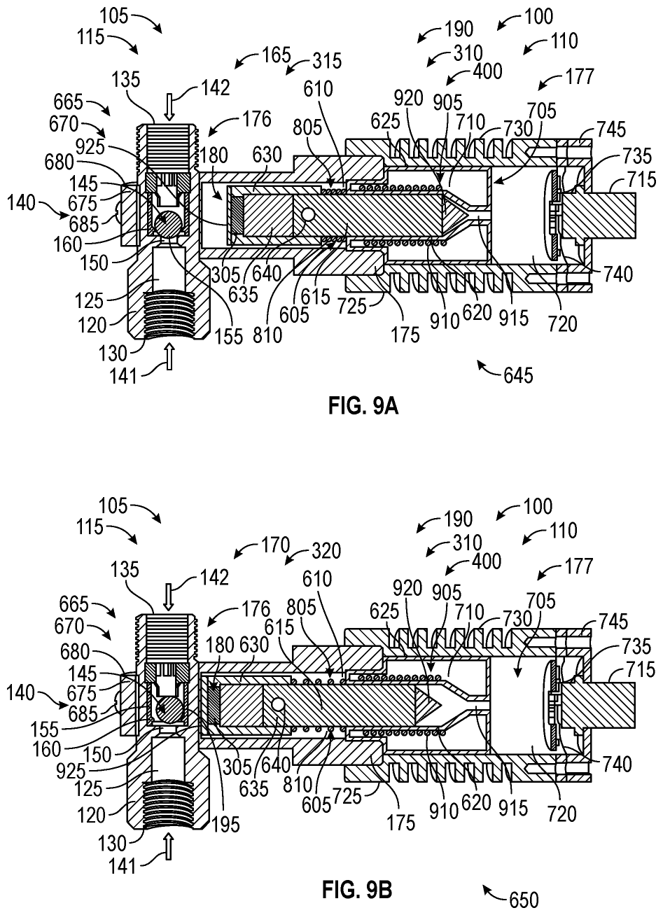

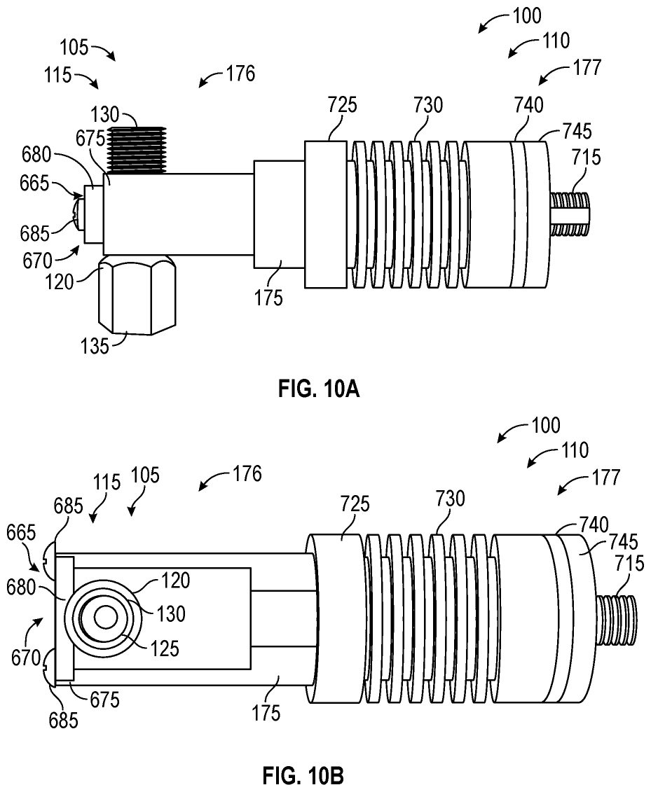

A particular version of a flow control system 100 according to the invention is shown in FIGS. 9A and 9B. FIGS. 9A and 9B show some additional optional and/or specific features that can be incorporated with any of the previously described versions. For example, the electromechanical actuator 710 in this version comprises a solenoid 905 that includes a wire coil 910 that extends around the channel 620 that contains the plunger member 615. The wire coil 910 operates as an electromagnet and when current is supplied to the wire coil 810 a magnetic force urges the plunger member 615 in one direction or the other. As is also shown in the version of FIGS. 9A and 9B, the channel 620 in the actuator device body 625 includes an air passageway 915 that allows air to move into and out of the channel 620 as the plunger member 615 moves. A rear plunger piece 920 can be provided to contour to the shape of the channel 620. In one version, the rear plunger piece 920 is made of a plastic material so that it can help dampen the return stroke of the plunger member 615. Also in the version of FIGS. 9A and 9B is shown an optional cover member 925 that covers the magnetic field generator 180. The cover member 925, which can be made of plastic, helps prevent the magnetic field generator 180 and in particular a permanent magnet 305 from contacting the front end 176 with too much force, without which it might break. FIGS. 10A and 10B show side and top views, respectively, of the version of FIGS. 9A and 9B.

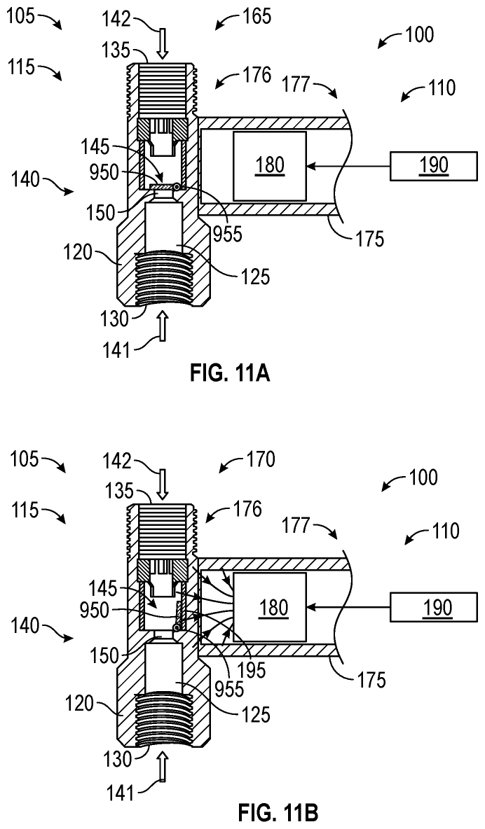

FIGS. 11A and 11B show another version of flow control system 100 of the invention with a different type of automatic check valve 115. In this version, the blocking member 145 comprises a disk 950 or other shaped objected that is pivotally attached at a hinge 955 so that it swings open with flow in the flow direction 141 and that swings closed with flow in the counter direction 142 under normal, uninhibited operation. In the inhibited condition 170, the magnetic field 185 causes the disk 950 which is made of ferromagnetic material to swing to the open position and thus allows flow in the counter flow direction 142. Optionally, a torsion spring or the like can be provided to bias the disk 950 towards the closed position. Any of the above discussed versions of the check valve inhibitor 110 can be used with the check valve 105 of FIGS. 11A and 11B.

The flow control system 100 of the invention is useful in any situation where it can be at time desirable to inhibit the operation of a check valve 105 and particularly an automatic check valve 115. In one particularly useful application, one or more flow control systems 100 can be used in a flow system where chemicals, such as oil, are passed. In such systems a plunger in a pump head to pull chemical though an inlet check valve and displace chemical though an outlet check valve. There is typically a single pump, drive, and motor operates two such set ups with each set up including a plunger, a pump head, and two check valves. In such a system, each output will inject the same amount unless one of the plunger sizes or stroke lengths are changed. Accordingly, to effect a change in injection rates between the two heads, a manual, on site process must be employed that is difficult and time consuming, and limited injection rate differential can be achieved. Using the flow control system 100 of the present invention in place of the conventional check valves, the pump can achieve precise individual injection rates while using a single drive and motor by controlling the inhibition of each of the check valves.

In one version, the flow control system 100 of the invention in any of the versions described or in any combination of the versions described can be provided as a combination of a check valve 105 and a check valve inhibitor 110. The check valve 105 and the check valve inhibitor 110 can be preattached and/or preassembled together and provided as a single unit comprising both the check valve 105 and the check valve inhibitor 110. Alternatively, the check valve 105 and the check valve inhibitor 110 can be provided as separate parts that can be later attached or that can be used in an unattached manner. Alternatively, the flow control system 100 can comprise a check valve inhibitor 110 that is provided on its own and that is adapted to be used with and to inhibit a check valve 105 as described herein and/or as commercially available.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/−ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A flow control system comprising:
a check valve having a flow channel extending from an inlet to an outlet, the check valve having a valving mechanism positioned between the inlet and the outlet; and
a check valve inhibitor positionable in proximity to the valving mechanism to control the operation thereof, the check valve inhibitor comprising a magnetic field generator capable of generating a magnetic field that is selectively operable on the valving mechanism,
wherein the check valve inhibitor can place the check valve in an uninhibited condition where flow in the outlet to inlet direction is blocked, and wherein the check valve inhibitor can place the check valve in an inhibited condition where flow in the outlet to inlet direction is allowed.

2. A flow control system according to claim 1 wherein the check valve is an automatic check valve.

3. A flow control system according to claim 1 wherein the check valve is placed in the inhibited condition by subjecting the valving mechanism to the magnetic field.

4. A flow control system according to claim 1 wherein the check valve inhibitor comprises an inhibition actuator that controls the selectively operable magnetic field in a manner that moves the check valve from the uninhibited condition to the inhibited condition.

5. A flow control system according to claim 1 wherein the check valve inhibitor comprises an inhibition actuator that controls the selectively operable magnetic field in a manner that moves the check valve from the uninhibited condition to the inhibited condition, wherein the magnetic field generator is an electromagnet and wherein the inhibition actuator controls the strength of the magnetic field produced by the electromagnet.

6. A flow control system according to claim 1 wherein the check valve inhibitor comprises an inhibition actuator that controls the selectively operable magnetic field in a manner that moves the check valve from the uninhibited condition to the inhibited condition, wherein the magnetic field generator is an electromagnet and wherein the inhibition actuator turns the electromagnet on to place the check valve in the inhibited condition and turns the electromagnet off to place the check valve in the inhibited condition.

7. A flow control system according to claim 1 wherein the check valve inhibitor comprises an inhibition actuator that controls the selectively operable magnetic field in a manner that moves the check valve from the uninhibited condition to the inhibited condition, wherein the magnetic field generator is a permanent magnet, and wherein the inhibition actuator controls the position of the permanent magnet relative to the valving mechanism.

8. A flow control system according to claim 1 wherein the check valve inhibitor comprises an inhibition actuator that controls the selectively operable magnetic field in a manner that moves the check valve from the uninhibited condition to the inhibited condition, wherein the magnetic field generator is a permanent magnet, wherein the inhibition actuator controls the position of the permanent magnet relative to the valving mechanism, and wherein the check valve inhibitor comprises a housing attachable to the check valve, and wherein the permanent magnet is moveable within the housing.

9. A flow control system according to claim 1 wherein the check valve inhibitor comprises an inhibition actuator that controls the selectively operable magnetic field by adjusting the position of the magnetic field generator, wherein the magnetic field generator is positionable by the inhibition actuator in a first position to place the check valve in the uninhibited condition, and wherein the magnetic field generator is positionable by the inhibition actuator in a second position to place the check valve in the inhibited condition.

10. A flow control system according to claim 9 wherein the inhibition actuator comprises a plunger mechanism adapted to move the magnetic field generator from the first position to the second position.

11. A flow control system according to claim 10 wherein the inhibition actuator comprises an electromechanical actuator, wherein the electromechanical actuator causes the plunger mechanism to move the magnetic field generator to the first position or to the second position in response to an electrical signal.

12. A flow control system according to claim 11 wherein the inhibition actuator comprises a biasing mechanism that biases the plunger mechanism so that the magnetic field generator is biased towards the first position or the second position, and wherein the electromechanical actuator is capable of urging the plunger member against the bias from the biasing mechanism when the electromechanical actuator is activated.

13. A flow control system according to claim 9 wherein the inhibition actuator comprises a biasing mechanism that biases the magnetic field generator towards the first position or the second position.

14. A check valve inhibitor for a check valve in a flow control system, the check valve inhibitor comprising:
an attachment mechanism adapted to allow the check valve inhibitor to be attached to a check valve, the check valve having a flow channel extending from an inlet to an outlet, the check valve having a valving mechanism positioned between the inlet and the outlet; and
a magnetic field generator capable of generating a magnetic field that is selectively operable on the valving mechanism,
wherein the check valve inhibitor is adapted to control the operation of the check valve by being able to selectively place the check valve in an uninhibited condition where flow in the outlet to inlet direction is blocked and by being able to selectively place the check valve in an inhibited condition where flow in the outlet to inlet direction is allowed.

15. A check valve inhibitor according to claim 14 wherein the check valve inhibitor comprises an inhibition actuator that controls the selectively operable magnetic field in a manner that moves the check valve from the uninhibited condition to the inhibited condition.

16. A check valve inhibitor according to claim 14 wherein the check valve inhibitor comprises an inhibition actuator that controls the selectively operable magnetic field in a manner that moves the check valve from the uninhibited condition to the inhibited condition, wherein the magnetic field generator is an electromagnet and wherein the inhibition actuator controls the strength of the magnetic field produced by the electromagnet.

17. A check valve inhibitor according to claim 14 wherein the check valve inhibitor comprises an inhibition actuator that controls the selectively operable magnetic field by adjusting the position of the magnetic field generator, wherein the magnetic field generator is positionable by the inhibition actuator in a first position to place the check valve in the uninhibited condition, and wherein the magnetic field generator is positionable by the inhibition actuator in a second position to place the check valve in the inhibited condition.

18. A check valve inhibitor according to claim 17 wherein the inhibition actuator comprises a plunger mechanism adapted to move the magnetic field generator from the first position to the second position, wherein the electromechanical actuator causes the plunger mechanism to move the magnetic field generator to the first position or to the second position in response to an electrical signal.

19. A check valve inhibitor according to claim 17 wherein the inhibition actuator comprises a plunger mechanism adapted to move the magnetic field generator from the first position to the second position, wherein the electromechanical actuator causes the plunger mechanism to move the magnetic field generator to the first position or to the second position in response to an electrical signal, and wherein the inhibition actuator comprises a biasing mechanism that biases the plunger mechanism so that the magnetic field generator is biased towards the first position or the second position, and wherein the electromechanical actuator is capable of urging the plunger member against the bias from the biasing mechanism when the electromechanical actuator is activated.

20. A method of controlling a check valve, the method comprising:
providing an automatic check valve, the automatic check valve having a flow channel extending from an inlet to an outlet, the check valve having a valving mechanism positioned between the inlet and the outlet;
positioning a check valve inhibitor in proximity to the valving mechanism of the automatic check valve, the check valve inhibitor comprising a magnetic field generator; and
operating the magnetic field generator to control the operation of the check valve by selectively being able to place the check valve in an uninhibited condition where flow in the outlet to inlet direction is blocked, and selectively being able to place the check valve in an inhibited condition where flow in the outlet to inlet direction is allowed.
